(19) United States
(12) Patent Application Publication
(10) Pub. No.: US 2012/0293679 A1
(43) Pub. Date: Nov. 22, 2012

(54) IMAGE PROCESSING APPARATUS AND ITS CONTROL METHOD AND PROGRAM

(75) Inventors: Toshitaka Aiba, Tokyo (JP); Hiroto Oka, Machida-shi (JP)

(73) Assignee: CANON KABUSHIKI KAISHA, Tokyo (JP)

(21) Appl. No.: 13/451,804

(22) Filed: Apr. 20, 2012

(30) Foreign Application Priority Data
May 16, 2011 (JP) 2011-109410

(51) Int. Cl. H04N 5/228

(52) U.S. Cl. 348/222.1; 348/E05.031

(57) ABSTRACT

An image processing apparatus calculates an actual reproduction frame rate from a reproduction speed and a frame rate of a moving image file and compares the actual reproduction frame rate with a predetermined frame rate. A display manner of image information of the moving image file is chanced in accordance with a comparison result.

### BACKGROUND OF THE INVENTION

1. Field of the Invention

The present invention relates to an image processing apparatus in which moving images shot at different frame rates are reproduced at an arbitrary reproduction speed.

2. Description of the Related Art

In the related art, a moving image shot at a frame rate which is extremely lowered (1 fps) is reproduced at a normal frame rate (30 fps), thereby reproducing the moving image at a speed which is 30 times as high as a speed upon shooting (refer to the Official Gazette of Japanese Patent Application Laid-Open No. 2003-252373). There is also a case where the shooting frame rate is raised to shoot a moving image or a case where a reproduction speed is adjusted to reproduce a moving image (refer to the Official Gazette of Japanese Patent Application Laid-Open No. 2002-320203).

When the user sets an arbitrary reproduction speed to reproduce the moving image, there is a case where a reproduction frame rate corresponding to the set reproduction speed is lowered and the reproduced moving image looks badly due to an unusual motion thereof. In order to reproduce the moving image so as to look good, since the user has to retrieve and reset an optimum reproduction speed by making trial and error, it is troublesome.

It is, therefore, an aspect of the invention that such a reproduction speed that a reproduced moving image appears with an unusual motion thereof is recognizably notified to the user, thereby reducing a troublesomeness of the user.

### SUMMARY OF THE INVENTION

According to an aspect of the present invention, an image processing apparatus compares a reproduction frame rate that is calculated from a reproduction speed designated in order to reproduce a recorded moving image and a frame rate recorded in relation to the moving image, with a predetermined frame rate and determines whether or not a predetermined informing regarding a reproduction at the designated reproduction speed is performed to the moving image, in accordance with a result of the comparison.

Further features of the present invention will become apparent from the following description of exemplary embodiments with reference to the attached drawings.

### BRIEF DESCRIPTION OF THE DRAWINGS

FIG. 1 is a block diagram illustrating a construction of an image processing apparatus in the first embodiment of the invention.

FIG. 2 is a diagram illustrating a user interface of the image processing apparatus of the first embodiment of the invention.

FIG. 3 is a diagram illustrating a flowchart of operation of the image processing apparatus of the first embodiment of the invention, performed when being activated.

FIG. 4 is a diagram illustrating a processing flowchart which is executed when a user interface of the image processing apparatus of the first embodiment of the invention is operated.

FIG. 5 is a diagram illustrating a flowchart for a retrieval of a moving image to be subjected to informing and an informing processing which are executed in step S411 in FIG. 4.

### DESCRIPTION OF THE EMBODIMENTS

Exemplary embodiments of the present invention will be described in detail hereinbelow with reference to the drawings.

### First Embodiment

An image processing apparatus of the present embodiment is realized by means of an application which operates on a PC.

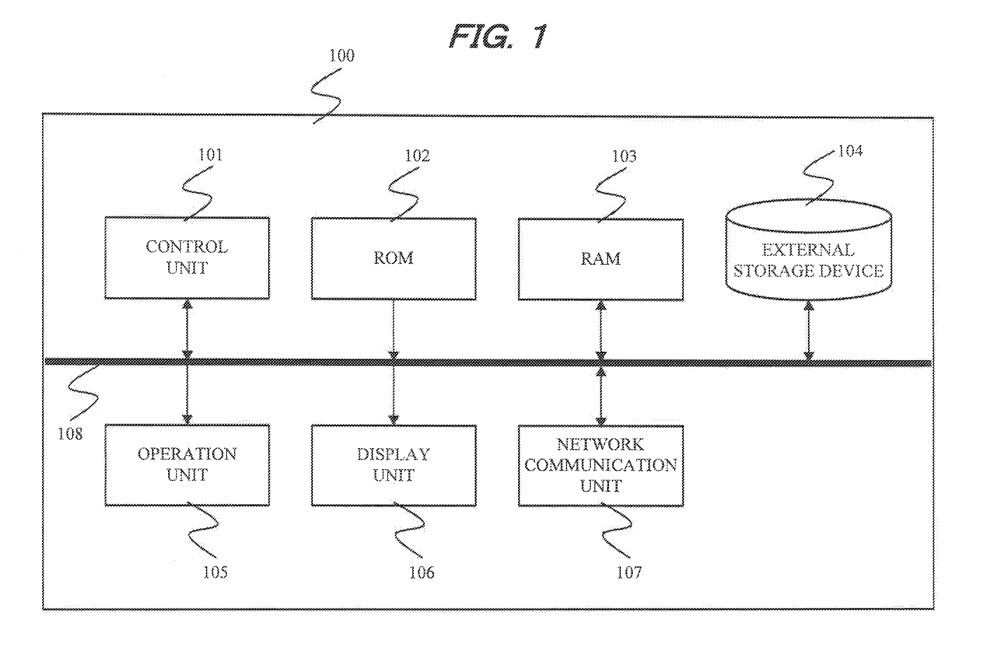

FIG. 1. is a block diagram illustrating a construction of the image processing apparatus according to the first embodiment of the invention.

In FIG. 1, a control unit 101 controls a whole image processing apparatus 100 and is, for example, a CPU (Central Processing Unit). A program and parameters which do not need to be changed have been stored in a ROM (Read Only Memory) 102. A program and data which are supplied from an external apparatus or the like are temporarily stored into a RAM (Random Access Memory). Reference numeral 104 denotes a hard disk or memory card built in the image processing apparatus 100 or an external storage device including a floppy (registered trademark) disk (FD), an optical disc such as a CD (Compact Disc) or the like, a magnetic or optical memory card, an IC card, or the like arranged to be detachable to/from the image processing apparatus 100. An operation unit 105 includes a mouse, a keyboard, or the like for inputting data in response to the operation of the user. A display unit 106 displays the data held in the image processing apparatus 100 or the supplied data. A network communication unit 107 is connected to a network line such as Internet or the like and is used to communicate. A system bus 108 connects each of the above units 101 to 107 so that the respective units can communicate with each other. An image reproducing program, which will be described hereinafter, has been stored in the external storage device 104 as a program code which can be read by the control unit 101. The control unit 101 reads out and executes the program code.

An example of the operation which is executed by the image processing apparatus constructed as mentioned above will be described hereinbelow.

First, a moving image file in the present embodiment is obtained by the high-speed shooting and has a high shooting frame rate, and the same frame rate as the shooting frame rate is recorded as a reproduction frame rate in the moving image file. The shooting frame rate and the reproduction frame rate are recorded in meta data of the moving image file. The moving image file has been recorded in the external storage device 104.

Subsequently, an outline of the image processing apparatus of the present embodiment will be described hereinbelow.

In the image processing apparatus of the present embodiment, a predetermined fixed value is set as such a limit value of the frame rate that the reproduced moving image first visually appears to a person with an unusual motion thereof because a reproduction speed of the moving image is lowered and the frame rate decreases and is held in the external storage device 104. In the present embodiment, a predetermined frame rate is assumed to be 30 fps. In the present embodiment, a range of the reproduction speed at which the frame rate is lower than the limit value is discriminated and displayed, thereby informing the operator. When the operator reproduces the moving image at the set reproduction speed, a display manner of the moving image file in which the frame rate is lower than the limit value is changed, thereby informing the operator.

The control unit 101 activates the image reproducing program and makes display control so as to display a display screen 200 to the display unit 106.

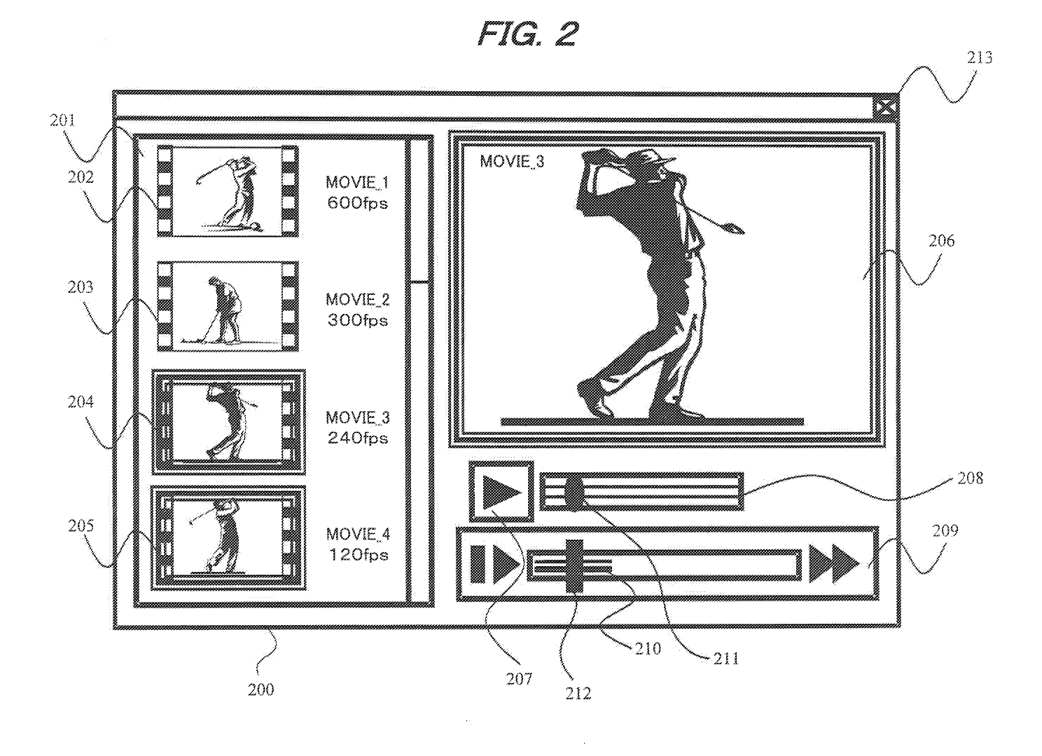

An example of the display screen 200 of the image reproducing program in the embodiment is illustrated in FIG. 2.

In FIG. 2, a list of thumbnail image corresponding to the moving image file stored in the external storage device 104 in FIG. 1 is displayed in an area 201. The control unit 101 reads out the moving image file stored in the external storage device 104, forms thumbnail images, and outputs a list of the thumbnail images to the display screen 200. Four thumbnail images 202, 203, 204, and 205 are displayed in FIG. 2. Image information such as a file name or the like regarding the moving image file may be displayed instead of the thumbnail images. When the operator operates the operation unit 105 and selects one of the thumbnail images, the control unit 101 reproduces the moving image file corresponding to the selected thumbnail image to a moving image display window 206. In FIG. 2, the thumbnail image 204 is selected and moving image file (MOVIE_3) corresponding thereto is reproduced in the moving image display window 206.

The shooting frame rate of each corresponding moving image file is equal to 600 fps for the thumbnail image 202, 300 fps for the thumbnail image 203, 2400 fps for the thumbnail image 204, and 120 fps for the thumbnail image 205, respectively,

A reproduction button 207 is provided to designate the reproducing operation of the moving image file. When the operator depresses the reproduction button 207 by operating the operation unit 105 before reproduction of the moving image file, the control unit 101 controls so as to start the reproduction of the moving image file of the moving image display window 206. When the reproduction button 207 is depressed during the reproduction of the moving image file, the control unit 101 controls so as to stop the reproduction of the moving image file.

A time slider bar 208 is provided to designate a reproduction position of the moving image file. A knob iron 211 to display the reproduction position of the moving image file is provided on the time slider bar 208. The control unit 101 updates the display screen so as to move the knob icon 211 in accordance with a reproduction processing of the moving image and indicates the current reproduction position of the moving image file. When the operator operates the knob icon 211 on the time slider bar 208 by operating the operation unit 105, the control unit 101 changes the current reproduction position of the moving image file displayed in the moving image display window 206 to the position corresponding to a position of the knob icon 211.

A speed-change slider bar 209 is provided to adjust the reproduction speed of the moving image file.

The speed-change slider bar 209 has a slider 212 at a position corresponding to a setting value of the reproduction speed. When the operator moves the slider 212 by operating the operation unit 105, the control unit 101 changes the reproduction speed of the moving image file. In the present embodiment, it is assumed that a position of the slider 212 corresponds to a magnification of the reproduction speed to the reproduction frame rate of the moving image file. In the present embodiment, it is assumed that the setting value set on the speed-change slider bar 209 is maintained even if the moving image file which is reproduced in the moving image display window 206 is switched. In FIG. 2, it is assumed that the more leftwardly the slider 212 is moved on the speed-change slider bar 209, the smaller the magnification is set to be, while the more rightwardly the slider 212 is moved, the larger the magnification is set to be. In the present embodiment, it is also assumed that the speed-change slider bar 209 is arranged to set the magnification within a range thereof from one twentieth ( 1/20) time to 20 times.

Each of the thumbnail images 204 and 205 is displayed by being surrounded by a double-line frame so as to emphasize the display more than an image surrounded by a single-line frame like images 202 and 203. This informs the operator of a fact that if the moving image files (MOVIE_3, MOVIE_4) of the thumbnail images 204 and 205 are reproduced at the reproduction speed corresponding to the position of the slider 212 on the speed-change slider bar 209, an actual reproduction frame rate is lower than a limit value. Thus, the operator can easily discriminate the moving image which appears with an unusual motion thereof when being reproduced by the setting value of the current reproduction speed.

The moving image display window 206 is also displayed by being surrounded by a double-line frame. This informs the operator of a fact that if the moving image file (MOVIE_3) displayed in the moving image display window 206 is reproduced at the reproduction speed corresponding to the position of the slider 212 on the speed-change slider bar 209, the actual reproduction frame rate is lower than the limit value. Thus, the operator can easily recognize a fact that the moving image which appears with an unusual motion thereof if it is reproduced based on the setting value of the current reproduction speed. While, during the reproduction of the moving image file, it is readily recognizable that due to the inappropriate setting value of the reproduction speed, the reproduced moving image appears with an unusual motion thereof.

A range 210 of the reproduction speed which provides such a frame rate that the current moving image file displayed in the moving image display window 206 appears with an unusual motion thereof when being reproduced is emphasized and displayed on the speed-change slider bar 209. For example, the range 210 is displayed by a line thicker than those of other ranges, is displayed in a color different from those of other ranges, or is displayed in a blinking. Thus, when the operator moves the slider 212 to the range 210 by operating the operation unit 105 and sets the reproduction speed corresponding to the position of the slider, it turns out before the fact that the moving image appears with an unusual motion thereof when being reproduced. For example, if the reproduction frame rate of the moving image file (MOVIE_3) displayed in the moving image display window 206 is equal to 240 fps, the range 210 is set to a magnification in a range where it is smaller than one eighth (⅛) time serving as a limit value (30 fps). The range 210 may be set so as to indicate a magnification in a range where it is smaller than the magnification serving as a limit value of the moving image file of the smallest frame rate existing in the moving image file list instead of the moving image file displayed in the moving image display window 206.

An end button 213 is provided to designate an end of the image reproducing program.

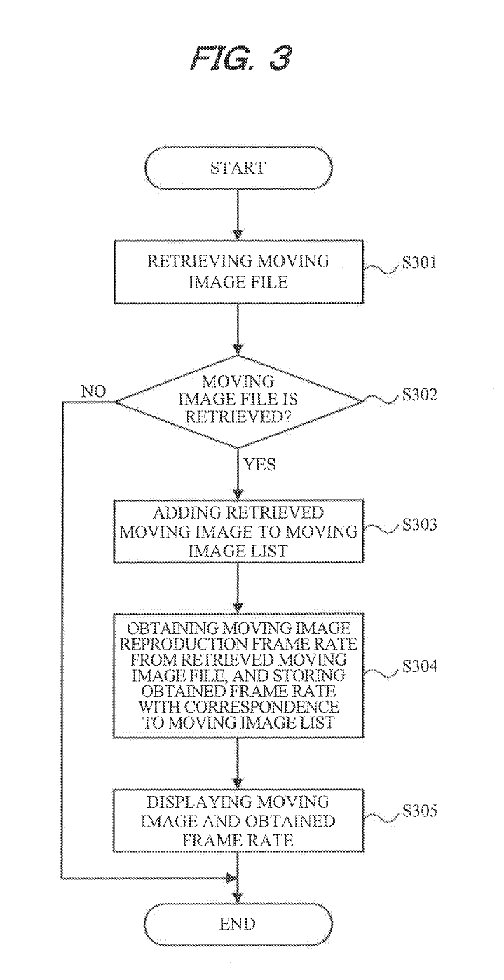

FIG. 3 is a diagram illustrating a flowchart for processings in which after the image reproducing program is read out from the external storage device 104, a thumbnail list of moving images is formed from the moving image file in the external storage device 104 in FIG. 1, and the display screen of FIG. 2 is displayed.

In. FIG. 3, in step S301, the control unit 101 retrieves the moving image file from the external storage device 104.

In step S302, the control unit 101 discriminates whether or not the moving image file has been retrieved in step S301. If the moving image file is retrieved, the control unit 101 shifts a processing routine to step S303. If the moving image file is not retrieved, the processing routine is finished.

In step S303, the control unit 101 forms a thumbnail image from the moving image file retrieved in step S301 and stores into the external storage device 104.

In step S304, the control unit 101 obtains the reproduction frame rate from the moving image file retrieved in step S301. The control unit 101 adds the obtained reproduction frame rate to the moving image list in relation to a file path of the thumbnail image stored in step S303 and holds in the external storage device 104. In the present embodiment, the file paths of the thumbnail images 202, 203, 204, and 205 of the respective moving image files and the reproduction frame rates 600 fps, 300 fps, 240 fps, and 120 fps of the respective moving images are held in the moving image list in correspondence to each other.

In step S305, the control unit 101 makes display control so as to display the display screen 200 to the display unit 106. The thumbnail images and the reproduction frame rates of the moving image files are displayed on the display screen 200 on the basis of the moving image list.

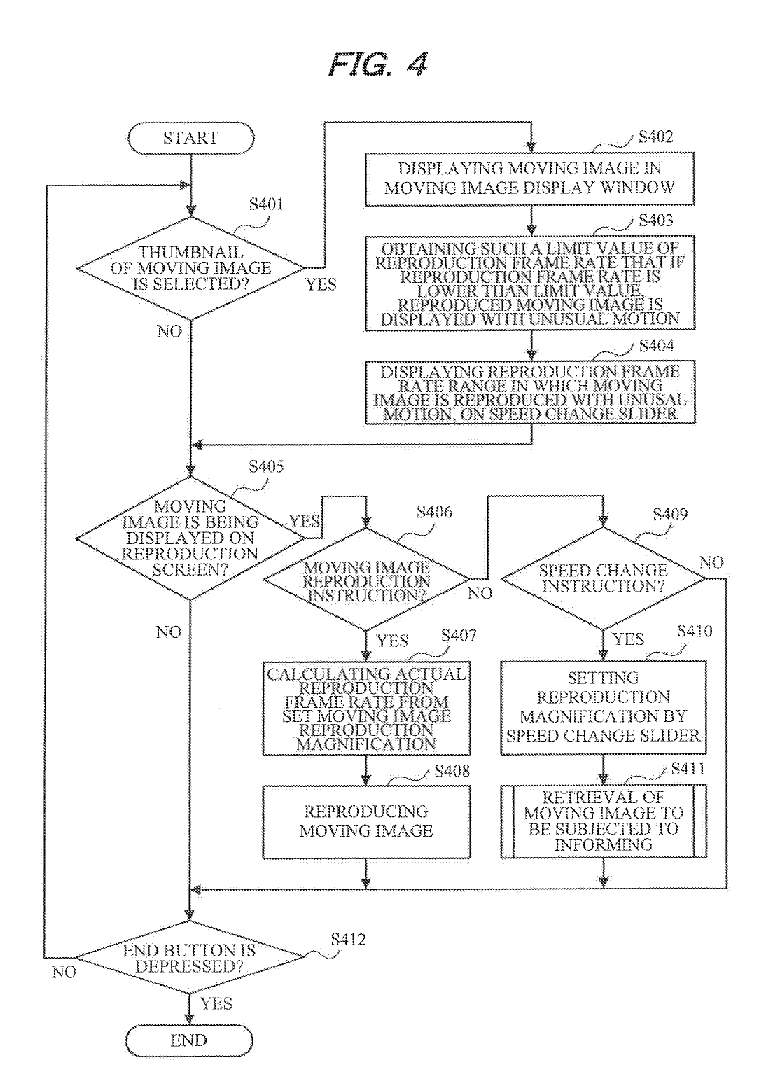

FIG. 4 is to diagram illustrating a flowchart of processings which are executed when the user operates the list of the thumbnail images on the display screen 200, the reproduction button 207, the time slider bar 208, the speed-change slider bar 209, and the end button 213 by the operation unit 105.

In step S401, the control unit 101 discriminates whether or not one of the thumbnail images has been selected from the list of the thumbnail images by the operation of the operation unit 105 is discriminated. If it is determined that one of the thumbnail images has been selected, the control unit 101 shifts the processing routine to step S402. If it is determined that the thumbnail image is not selected, the processing routine advances to step S405.

In step S402, the control unit 101 allows the moving image file of the thumbnail image selected in step S401 to be displayed to the moving image display window 206.

In step S403, the control unit 101 obtains a limit value of such a reproduction frame rate that the moving image appears with an unusual motion thereof when being reproduced. The limit value is held in the image processing apparatus as a predetermined fixed value. In the embodiment, it is set to 30 fps. As a value other than 30 fps, 24 fps used in a movie as a frame rate which is generally known as a frame rate at which the reproduced moving image appears with a smooth motion or 25 fps used in PAL may he used. It is also possible to construct in such a manner that the operator can designate an arbitrary value and such a value is obtained.

In step S404, the control unit 101 allows the range 210 of such a reproduction speed that the reproduced image of the moving image file displayed in the moving image display window 206 appears with an unusual motion thereof to be displayed onto the speed-change slider bar 209 on the basis of the limit value obtained in step S403. The control unit 101 calculates the magnification which provides the limit value of the reproduction frame rate of the moving image displayed in the moving image display window 206 and allows the range 210 of a magnification smaller than such a magnification to be emphasized and displayed. If the reproduction frame rate of the moving image is equal to 240 fps, the magnification which provides the limit value of 30 fps is equal to ⅓. Therefore, a range of the magnification smaller than ⅛ is emphasized and displayed onto the speed-change slider bar 209.

In step S405, the control unit 101 discriminates whether or not the moving image file is displayed in the moving image display window 206. If it is determined that the moving image file is displayed, the control unit 101 shifts the processing routine to step S406. If it is determined that the moving image file is not displayed, the processing routine advances to step S412.

In step S405, the control unit 101 discriminates the presence or absence of a reproduction instruction of the moving image file. The reproduction of the moving image file is instructed when the operator depresses the reproduction button 207 by operating the operation unit 105. If it is determined by the control unit 101 that there is a reproduction instruction of the moving image file, the processing routine advances to step S407. If it is determined that there is not a reproduction instruction of the moving image file, step S409 follows.

In step S407, the control unit 101 calculates an actual reproduction frame rate on the basis of the reproduction speed (magnification corresponding to the position of the slider 212) set on the speed-change slider bar 209 and the reproduction frame rate recorded in the moving image file. The actual reproduction frame rate is calculated by multiplying the reproduction frame rate of the moving image file by the magnification of the reproduction speed.

In step S408, the control unit 101 reproduces the moving image file at the actual reproduction frame rate calculated in step S407. The reproduction of the moving image file is started from the position set by the time slider bar 208 (position corresponding to the knob icon 211).

In step S409, the control unit 101 discriminates the presence or absence of a speed change instruction. The speed change is instructed when the operator depresses the slider 212 on the speed-change slider bar 209 by operating the operation unit 105. If it is determined that there is a speed change instruction, the control unit 101 shifts the processing routine to step S410. If it is determined that there is not a speed change instruction, step S412 follows.

In step S410, the control unit 101 obtains a value corresponding to the position of the operated slider 212 on the operated speed-change slider bar 209 and sets as a magnification of the reproduction speed.

In step S411, the control unit. 101 retrieves the moving image file which appears with an unusual motion thereof when being reproduced at the reproduction speed set in step S410 from the moving image list. The processes which are executed here will be described in detail hereinafter.

In step S412, the control unit 101 discriminates whether or not the operation to depress the end button 213 is performed by the operation of the operation unit 105. If it is determined that the end button 213 is depressed, the operation unit 105 finishes the image reproducing program. If it is determined that the end button 213 is not depressed, the control unit 101 shifts the processing routine to step S401 and repeats steps S401 to S412.

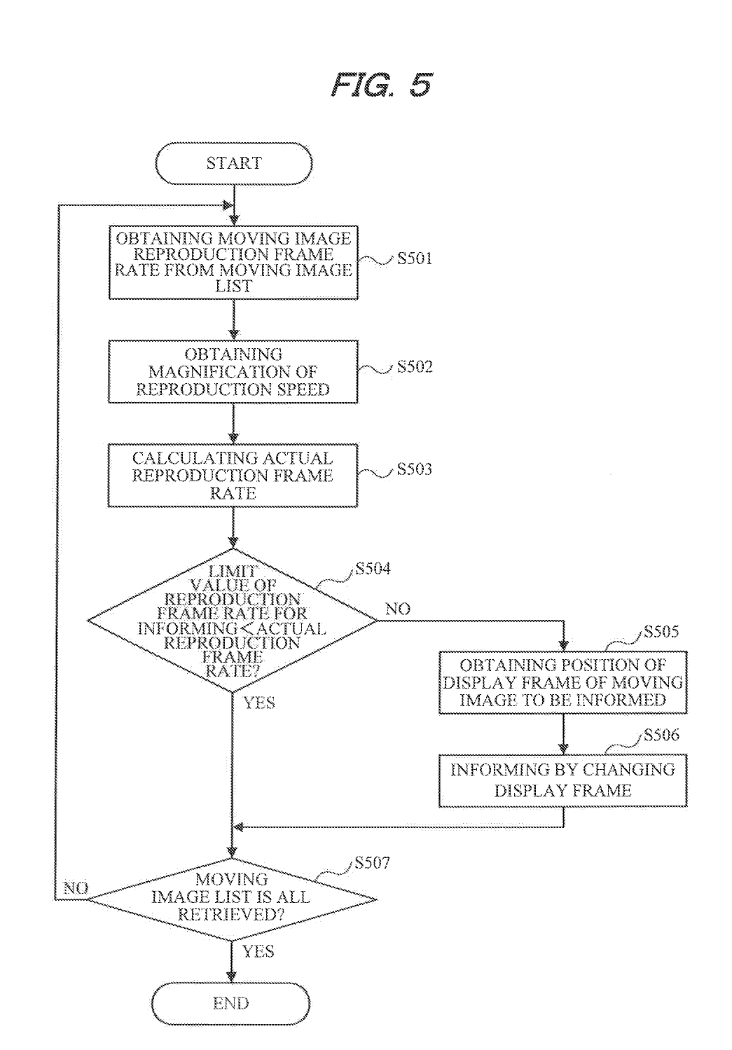

FIG. 5 is a diagram illustrating a flowchart for a processing of step S411 in FIG. 4.

In step S501, the control unit 101 obtains the reproduction frame rate of one of the moving image files existing in the moving image list formed in step S303 in FIG. 3.

In step S502, the control unit 101 obtains the magnification of the reproduction speed set by the speed-change slider bar 209. in the embodiment, the slider 212 is moved on the speed-change slider bar 209 by the operator of the image processing apparatus, so that the magnification of one tenth ( 1/10) time is set.

In step S503, the control unit 101 calculates the actual reproduction frame rate of each moving image file on the basis of the reproduction frame rate of the moving image file obtained in step S501 and the magnification of the reproduction speed obtained in step S502. For example, the reproduction frame rates of the moving image files of the thumbnail images 202, 203, 204, and 205 are equal to 600 fps, 300 fps, 240 fps, and 120 fps, respectively. Therefore, the actual reproduction frame rates of the moving image files of the thumbnail images 202, 203, and 205 are calculated as being 60 fps, 30 fps, and 12 fps, respectively.

In step S504, the control unit 101 compares the actual reproduction frame rates calculated in step S503 with the limit value and discriminates whether or not the actual reproduction frame rates are larger than the limit value. In the embodiment, the limit value is set to 30 fps. Therefore, for example, since the actual reproduction frame rate of the moving image file displayed in the moving image display window 206 is equal to 24 fps, it is determined that the actual reproduction frame rate is smaller than the limit value. Since the actual reproduction frame rates of the moving image files of the thumbnail images 202 and 203 are equal to 60 fps and 30 fps, it is determined that the actual reproduction frame rates are equal to or larger than the limit value. On the other hand, since the actual reproduction frame rate of the moving image file of the thumbnail image 205 is equal to 12 fps, it is determined that the actual reproduction frame rate is smaller than the limit value. If it is determined in step S504 that the actual reproduction frame rate is larger than the limit value, since there is no need to inform, the control unit 101 shifts the processing routine to step S507. If it is determined that the actual reproduction frame rate is not larger than the limit value, since it is necessary to inform, the processing routine advances to step S505.

In step S505, the control unit 101 obtains the position of a display frame of the moving image file which is determined in step S504 so that the actual reproduction frame rate is smaller than the limit value. As display frames of the moving image files, there are display frames of the thumbnail images 202, 203, 204, and 205 and a display frame of the moving image display window 206.

In step S506, the control unit 101 informs the operator by changing and displaying the display frame of the moving image file obtained in step S505 so as to emphasize a display manner of the display frame.

In the embodiment, by changing the display frame of the thumbnail image of the moving image file from the single line to the double line as illustrated in FIG. 2, the moving image file to be subjected to informing (serving as a frame rate at which the moving image file appears with an unusual motion thereof when being reproduced) is recognizably displayed. The display manner for identifying is not limited to a shape of the line of the frame but the color of the frame may be changed or the display manner may be changed so that the frame or the thumbnail image is displayed in blinking. As another method, the moving image file may be displayed by another display manner so long as the operator can recognize that a moving image file is such one that appears with an unusual motion thereof when being reproduced.

In step S507, the control unit 101 discriminates whether or not all of the moving image files described in the moving image list are retrieved. If it is determined that all of the moving image files described in the moving image list are retrieved, the control unit 101 finishes the processing routine. If it is determined that all of the moving image files described in the moving image list are not retrieved yet, the control unit 101 shifts the processing routine to step S501.

By repeating the processes in steps S501 to S507 as mentioned above, the control unit 101 decides the moving image file which appears with an unusual motion thereof when being reproduced, on the basis of the current setting value of the speed-change slider bar 209, and executes the informing of the decided moving image file to the operator.

As mentioned above, since the existence of the moving image file which appears with an unusual motion thereof when being reproduced at the set reproduction speed is informed on the basis of the magnification of the set reproduction speed, as illustrated in the display screen of FIG. 2, such a situation that the operator sets an improper reproduction speed and reproduces the moving image file can be prevented.

Since the range of the reproduction speed at which the moving image file which appears with an unusual motion thereof when being reproduced is informed, the operator can easily identify and set the proper reproduction speed.

in the present embodiment, it is assumed that the reproduction frame rate recorded in the moving image file is the same as the shooting frame rate, and the reproduction frame rate is obtained in step S304. However, if the frame rate different from the shooting frame rate is recorded in the moving image file as a reproduction frame rate, the shooting frame rate may be obtained and used as a reproduction frame rate in place of the reproduction frame rate in step S304.

Although the apparatus is constructed in such a manner that the magnification of the reproduction, speed is set by the speed-change slider bar 209 in the embodiment, the actual reproduction frame rate may be directly designated. The magnification to the shooting frame rate may be designated. By designating the magnification of the reproduction speed to the reproduction frame rate by the speed-change slider bar 209, change ratios of the reproduction speeds to a plurality of moving image files can be uniformly controlled. Therefore, the operability of the operator in the case where a change ratio of the moving image speed is fixed and a plurality of moving image files are successively switched and reproduced can be improved.

If the actual reproduction frame rate is directly designated by the speed-change slider bar 209, the reproduction speeds of a plurality of moving image files can be uniformly controlled. Therefore, the operability of the operator in the case where the reproduction frame rate of the moving image speed is fixed and a plurality of moving image files are successively switched and reproduced can be improved.

If the magnification to the shooting frame rate is designated by the speed-change slider bar 209, the reproduction speeds to the actual time at the time of shooting of a plurality of moving image files can be uniformly controlled. Therefore, the operator can easily judge whether or not the moving image files are reproduced slower or faster than the actual time when the moving image files are shot.

In The present embodiment, the example in which the frame rate at which the moving image file appears with an unusual motion thereof when being reproduced is set as a limit value (first limit value) and is selectively informed to the operator in accordance with a result of comparison with the actual reproduction frame rate has been described. However, the limit value is not limited to such a value. For example, the frame rate at which the thinning-out is performed may be set as a limit value (second limit value) on the basis of a display ability of the image processing apparatus. When the actual reproduction frame rate exceeds the second limit value, the image processing apparatus executes the thinning-out processing and, thereafter, reproduces the moving image files. The apparatus may be constructed in such a manner that the first and second limit values are combined and set. The image processing apparatus informs the operator of the reproduction speed at which the actual reproduction frame rate is smaller than the first limit value and the reproduction speed at which the actual reproduction frame rate is larger than the second limit value, thereby enabling the operator to easily recognize the improper reproduction speed.

If the actual reproduction frame rate is smaller than the first limit value or is larger than the second limit value in the case of the set reproduction speed, the moving image file may be reproduced at the frame rate of the first limit value or the second limit value. By reproducing the moving image file at the frame rate of the limit value, the moving image file can be made to appear with the smooth motion even when being reproduced.

Although the invention has been described in detail on the basis of the exemplary embodiments thereof, the invention is not limited to those specific embodiments but many various modifications within a range without departing from the spirit of the invention are also incorporated in the invention. Parts of the foregoing embodiments may be combined.

The invention also incorporates a case where a program of software for realizing the functions of the embodiments mentioned above is supplied to a system or apparatus having a program-executable computer directly from a recording medium or by using wired/wireless communication and the program is executed. Therefore, a program code itself which is supplied or installed into the computer in order to realize the functions and processings of the invention also realizes the invention. That is, the computer program itself to realize the functions and processings of the invention is also incorporated in the invention. In such a case, a code form of the program is not limited so long as it has the functions of the program and any one of an object code, a program which is executed by an interpreter, script data which is supplied to the OS, and the like may be used. As a recording medium to supply the program, for example, a hard disk, a magnetic recording medium such as a magnetic tape or the like, an optical/magnetooptic storage medium, or a non-volatile semiconductor memory may be used.

As a supplying method of the program, a method whereby a computer program to form the invention is stored into a server on a computer network and a client computer connected thereto downloads the computer program and executes the program is also considered.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-109410, filed on May 16, 2011, which is hereby incorporated by reference herein in its entirety.

What is claimed is:

1. An image processing apparatus comprising:
a display unit configured to display image information corresponding to a moving image file to a display portion;
reproduction unit configured to reproduce the moving image file;
a designation unit configured to designate a reproduction speed for reproducing the moving image file;
an obtaining unit configured to obtain a frame rate of the moving image file;
a calculation unit configured to calculate an actual reproduction frame rate from the reproduction speed designated by the designation unit and the frame rate obtained by the obtaining unit;
a comparison unit configured to compare the actual reproduction frame rate with a predetermined frame rate; and
a change unit configured to change a display manner of the image information in accordance with a result of the comparison.

2. An apparatus according to claim 1, wherein the actual reproduction frame rate which is calculated by the calculation unit is a product of the reproduction speed and the frame rate.

3. An apparatus according to claim 1, wherein
the display unit displays a slider bar for adjustment of the reproduction speed of the moving image file to the display portion, and
the designation unit designates the reproduction speed corresponding to a position of a slider on the slider bar.

4. An apparatus according to claim 3, wherein the display unit displays recognizably, on the slider bar, a range of the reproduction speed from which the actual reproduction frame rate being smaller than the predetermined frame rate as a result of the comparison is calculated by the calculation unit.

5. An apparatus according to claim 1, wherein when the actual reproduction frame rate is smaller than the predetermined frame rate as a result of the comparison, the reproduction unit reproduces the moving image file at the predetermined frame rate.

6. A control method of an image processing apparatus, comprising the steps of:
displaying image information corresponding to a moving image file to a display portion;
reproducing the moving image file;
designating a reproduction speed for reproducing the moving image file;
obtaining a frame rate of the moving image file;
calculating an actual reproduction frame rate from the designated reproduction speed and the obtained frame rate;
comparing the actual reproduction frame rate with a predetermined frame rate; and
changing a display manner of the image information in accordance with a result of the comparison.

7. A non-transitory computer-readable recording medium recording a program comprising a program code for causing a computer to execute the steps of:
displaying image information corresponding to a moving image file to a display portion;
reproducing the moving image file;
designating a reproduction speed for reproducing the moving image file;
obtaining a frame rate of the moving image file;
calculating an actual reproduction frame rate from the designated reproduction speed and the obtained frame rate;
comparing the actual reproduction frame rate with a predetermined frame rate; and
changing a display manner of the image information in accordance with a result of the comparison.
